(19) United States
(12) Patent Application Publication
(10) Pub. No.: US 2025/0312928 A1
(43) Pub. Date: Oct. 9, 2025

(54) RECONFIGURABLE WORKSPACE SOFT GRIPPER

(71) Applicant: Singapore University of Technology and Design, Singapore (SG)

(72) Inventors: Pablo Valdivia Y Alvarado Gutierrez, Singapore (SG); Snehal Ajit Jain, Singapore (SG); Saikrishna Dontu, Singapore (SG); Joanne Ee Mei Teoh, Singapore (SG)

(21) Appl. No.: 18/865,042

(22) PCT Filed: May 26, 2023
(86) PCT No.: PCT/SG2023/050372

§ 371 Date: Nov. 12, 2024

(30) Foreign Application Priority Data
May 27, 2022 (SG) 10202250024F

(51) Int. Cl. B25J 15/12

(52) U.S. Cl. CPC B25J 15/12

(57) ABSTRACT

A device including: a finger body, the finger body including one or more finger cavities disposed along a length of the finger body, the length of the finger body in a default shape defining a first axis, the finger body being bendable away from the first axis in response to a change in a finger fluid pressure in the one or more finger cavities; and a petal, the petal being coupled to the finger body at one or more points along the length of the finger body, the petal having one or more petal cavities disposed thereon, wherein the petal is actively deformable and/or passively deformable in response to the bending of the finger body and/or a change in a petal fluid pressure in the one or more petal cavities.

### CROSS-REFERENCE TO RELATED APPLICATION

The present application claims the benefit of priority to the Singapore application Ser. No. 10/202,250024F, filed May 27, 2022, the entire contents of which are incorporated herein by reference.

### TECHNICAL FIELD

The present application relates to end-effectors for robotic systems.

### BACKGROUND

Consumer goods, logistics, and food industries stand to benefit greatly from robotic automation to meet increasing and highly dynamic demands. However, despite the advances made in the field of robotics, the grasping capabilities of conventional grippers are considerably limited to handling articles of a pre-determined size or fixed geometry or size, as well as being constrained to performing highly specific grasping tasks. For example, the conventional soft end-effector has difficulty handling batches of items that are individually much smaller than the overall size of the batch, such as grains or beads. The conventional end-effectors capable of handling bulkier items, such as bottles, have difficulty handling items that are thin and small, such as cotton gauze strips or needles. This means that the automation of one production line could require multiple robotic arms, each with a different conventional end-effector installed, driving up costs. The alternative of using only one robotic arm would require multiple equipment downtime for the operator to switch out the end-effectors between different handling tasks. It can be appreciated that this alternative would negatively impact productivity.

### SUMMARY

In one aspect, the present device includes: a finger body, the finger body including one or more finger cavities disposed along a length of the finger body, the length of the finger body in a default shape defining a first axis, the finger body being bendable away from the first axis in response to a change in a finger fluid pressure in the one or more finger cavities; and a petal, the petal being coupled to the finger body at one or more points along the length of the finger body, the petal having one or more petal cavities disposed thereon, wherein the petal is actively deformable and/or passively deformable in response to the bending of the finger body and/or a change in a petal fluid pressure in the one or more petal cavities.

In another aspect, the present gripper includes: a palm defining a central axis; and a plurality of devices, each of the plurality of devices according to any device described above, wherein each of the plurality of devices is coupled to the palm via a respective coupling independently of any other of the plurality of devices, and wherein the respective finger body of the plurality of devices collectively define a working aperture, and wherein the plurality of devices and the palm collectively define a workspace volume.

In yet another aspect, the present gripper system includes: a control circuit; and a gripper according to any gripper described above, the gripper being operably coupled to the control circuit, wherein the control circuit is configured to control each of the following independently of any other in the group consisting of: the finger fluid pressure, the petal fluid pressure, and the palm fluid pressure.

### BRIEF DESCRIPTION OF THE DRAWINGS

Various embodiments of the present disclosure are described with reference to the following drawings to aid understanding:

FIG. 1 is a perspective view of a device for a reconfigurable workspace soft gripper according to one embodiment of the present disclosure;

FIG. 2 is a perspective sectional view of the device of FIG. 1;

FIG. 3 is an exploded view with partial cutaways of the device of FIG. 1;

FIG. 4A is a sectional side view of the device of FIG. 1 as viewed from A-A and FIG. 4B is a side view of FIG. 4A showing an outline of the device;

FIG. 5 schematically illustrates various exemplary configurations of the bellows on a petal;

FIG. 6 is an exploded perspective view of one embodiment of a reconfigurable workspace soft gripper having three units of the device of FIG. 1;

FIG. 7A and FIG. 7B are perspective views of the reconfigurable workspace soft gripper of FIG. 6;

FIG. 8A is a top view of the gripper of FIG. 7A, and FIG. 8B is a schematic diagram showing part of a gripper according to another embodiment of the present disclosure;

FIG. 9A is a top view of the gripper of FIG. 7A in a power grasping mode and FIG. 9B is a top view of the gripper of FIG. 7A in a pinch grasping mode;

FIG. 10 is a perspective view of the gripper of FIG. 7A in a scoop mode;

FIG. 11 is a perspective view of another embodiment of the gripper with flaps;

FIG. 12 is a top view of the gripper without inflating the set of bellows;

FIG. 13 is a top view of the gripper with the set of bellows inflated;

FIG. 14 is a partial sectional side view of the gripper of FIG. 8A as viewed from B-B;

FIG. 15 is a top view of the gripper of FIG. 14;

FIG. 16 is a perspective view of the gripper of FIG. 7A in a pinch mode;

FIG. 17 is a top view of the gripper of FIG. 16;

FIGS. 18A-18C are schematic diagrams illustrating the capability of the same gripper to pick up thin and/or small articles of different sizes;

FIG. 19 is a schematic diagram of an electro-pneumatic actuation circuit according to one embodiment of the present system;

FIGS. 20A-20L illustrate the capability of the same gripper to switch between two or more modes of operation and perform different handling tasks;

FIG. 21A and FIG. 21B illustrate the capability of the same gripper to switch between two or more modes of operation to pick up different articles of various shapes and sizes; and

FIG. 22 is a chart showing the different workspace volumes achievable using the same gripper in different modes of operation.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of a specified value.

As used herein, the term “and/or” includes any and all combinations of one or more of the associated listed items.

As used herein, “comprising” means including, but not limited to, whatever follows the word “comprising”. Thus, use of the term “comprising” indicates that the listed elements are required or mandatory, but that other elements are optional and may or may not be present. As used herein, “consisting of” means including, and limited to, whatever follows the phrase “consisting of”. Thus, use of the phrase “consisting of” indicates that the listed elements are required or mandatory, and that no other elements may be present.

Terms such as “first” and “second” are used in the description and claims only for the sake of brevity and clarity, and do not necessarily imply a priority or order, unless specified.

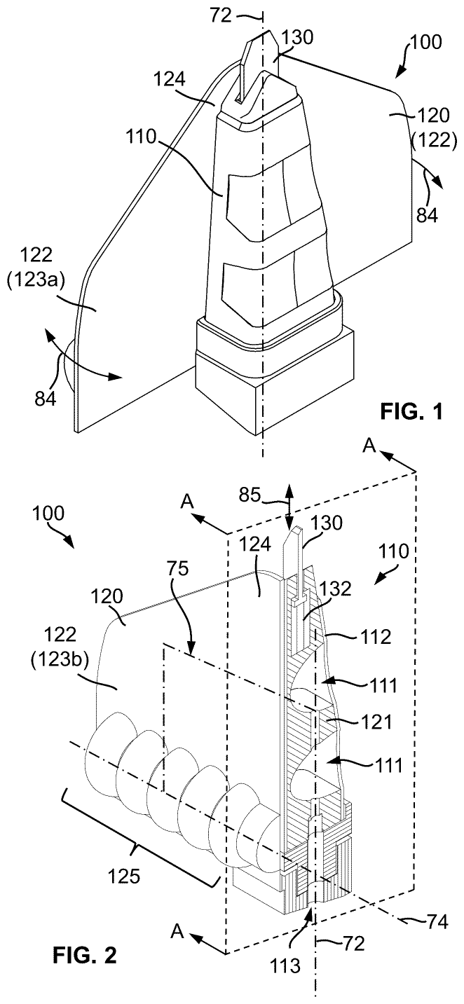

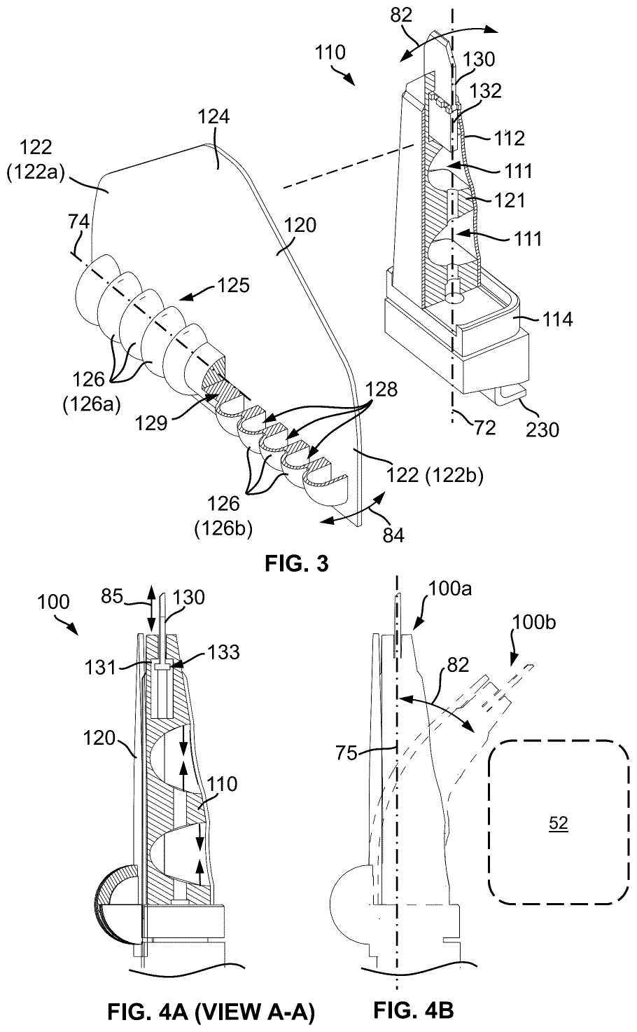

FIG. 1 to FIG. 5 illustrate an embodiment of a device 100 of a reconfigurable workspace soft (RWS) gripper 50 (hereinafter “gripper” for the sake of brevity) according to embodiments of the present disclosure. The device 100 may include a finger body 110 defining a first axis 72 and a petal 120 coupled to the finger body 110, the petal 120 defining a lateral axis 74, wherein the lateral axis 74 is transverse or perpendicular to the first axis 72. In some embodiments, the first axis 72 and the lateral axis 74 may collectively define a finger plane 75. In other embodiments, the planar form of the petal 120 may define the finger plane 75.

According to various embodiments, the finger body 110 may be formed using a wedge structure 121, defining one or more finger cavities 111 interior of the finger body 110. In some examples, the finger cavities 111 are preferably elliptical in cross-sectional shape, having cavity walls spaced apart from each other along the first axis 72. The finger cavities 111 do not necessarily need to be elliptical in cross-section. In various embodiments, the shape and size of each of the finger cavities 111, as well as the number of finger cavities 111 per finger body 110, may be configured with reference to the required deformation of the device 100. Non-limiting exemplary finger cavities 111 may be shaped based on various geometries such as but not limited to elliptical, triangular, polygonal, etc. In some embodiments, the finger body 110 may be wrapped around with an elastic skin 112 or a deformable skin sealing the finger cavities 111. Preferably the one or more finger cavities 111 may be in fluid communication with each other, and further be in fluid communication with a fluid inlet 113. The fluid inlet 113 may be in fluid communication with the fluid pressure controller 60 such that a pressure (finger fluid pressure) in the finger cavities 111 may be varied or changed.

In some embodiments, the finger body 110 may include a nail 130 or a finger tip resiliently coupled to the finger body 110, such that the nail 130 is resiliently displaceable (in a nail displacement action 85) along the first axis 72 relative to the finger body 110. For example, the nail 130 may be elastically coupled to the finger body 110, with the nail 130 being resiliently displaceable along the first axis 72 relative to the finger body 110. The nail 130 may further be telescopically coupled or slidably coupled to the finger body 110 via a channel 131 formed in the finger body 110. In an example, an elastic member 132 such as a compressible foam, may be disposed between the nail 130 and the finger body 110 such that the nail 130 is biased away from the finger body 110 while allowing the nail 130 to be elastically displaced towards or inwardly of the finger body 110. A limit stop 133 may be provided by a nail ledge 133 and a corresponding constriction in the channel 131, so as to prevent the nail 130 from sliding out of the channel 131.

Further referring to the figures, embodiments of the petal 120 are illustrated. The petal 120 may have a substantially flat (two-dimensional) or planar default shape that defines a first surface 123a and a second surface 123b (substantially opposing the first surface 123a). Alternatively, the petal 120 may have a default shape that is three-dimensional (3D) with one or more curved surface portions, or a more complex default shape. The petal 120 may be coupled to the finger body 110 at the first surface 123a, with the one or more petal cavities 126 disposed on the second surface 123b. The petal 120 is preferably an elastic member. To aid understanding, the petal 120 will be described in terms of an example having a generally triangular planar default form, but as described above, the default shape of the petal 120 may be varied. The petal 120 may include opposing lateral portions 122 and a tip portion 124 disposed between the opposing lateral portions 122. Preferably, the petal 120 is coupled to the finger body 110 via at least the tip portion 124 such that a displacement of the finger body 110 brings about a corresponding displacement of the tip portion 124, in other words, the tip portion 124 moves in tandem with the finger body 110 or at least a part of the finger body 110. In other embodiments, there may be multiple coupling points between the petal 120 and the finger body 110. Preferably, in various embodiments where the finger body 110 is bendable to provide a convex side and a generally opposing concave side (as schematically illustrated in FIG. 4B), the petal 120 is coupled to the convex side of the finder body 110. Preferably, the tip portion 124 of the petal 120 is coupled to the finger body 110 proximal the free end (near the channel 131) of the device 100, and another portion of the petal 120 is coupled to the engaged end 114 of the device 100. When the finger body 110 bends or unbends (whether by actuation or elastic bias), the overall shape of the petal 120 undergoes a corresponding deformation and/or a corresponding displacement (relative to the palm). Synergistically with the deformation and/or displacement resulting from being coupled to the finger body 110, the petal 120 is equipped with one or more sets of bellows that can controllably contribute to the resultant deformation and/or displacement of the petal 120. For the purpose of the present disclosure, “actively deformable” refers to a first element being deformable as a result of the first element being actuated (e.g., via a change in fluid pressure) to change in three-dimensional shape, and “passively deformable” refers the first element being deformable as a result of a second element being actuated (e.g., via a change in fluid pressure). The terms “passively deformable” may also include being deformable because of an elastic “spring back” effect, shape memory effect, etc., without an active deliver of one or more actuating forces.

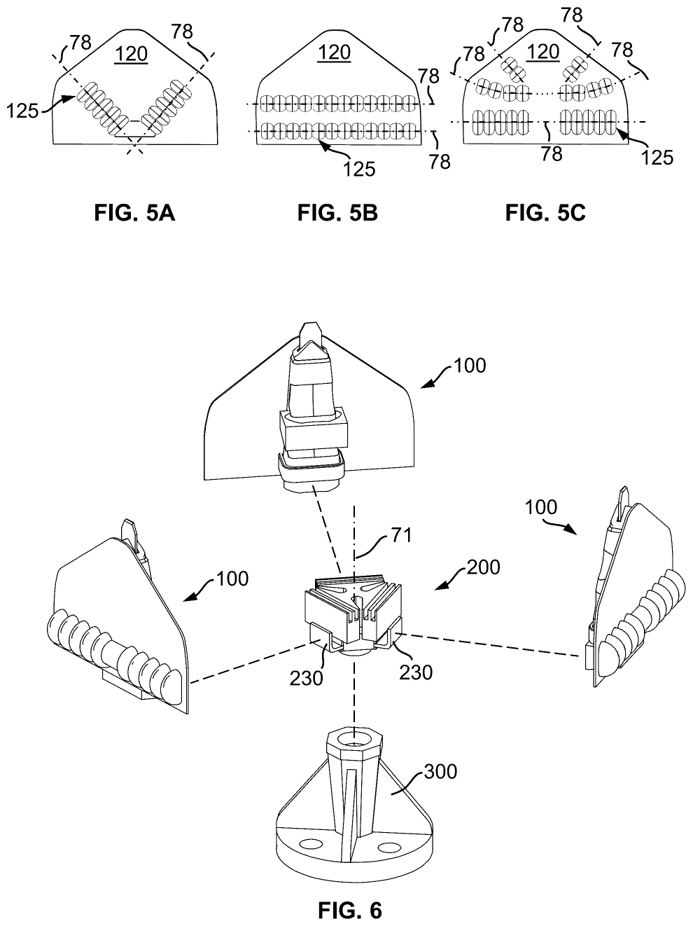

According to various embodiments, the petal 120 may include a set of bellows 125 having one or more elastic pockets 126 (e.g., petal cavities) distributed, disposed, or lined up along a bellow axis 78. The petal cavities 126 may be disposed on one or more than one surfaces of the petal 120. In some embodiments, the petal 120 is configured with a curved or complex 3D default shape, and the petal cavities 126 may be variously disposed on any one or more of the surfaces of the petal 120. The petal cavities 126 may be shaped and sized in various ways, and are not limited to the examples illustrated in the appended figures. In some embodiments, the bellow axis 78 may be substantially parallel to the lateral axis 74. In some embodiments, the bellow axis 78 may be non-parallel to the first axis 72. In various other embodiments, the petal 120 may include one or more sets of bellows 125 with respective bellow axes 78 in different orientations to bias the petal curvature in different ways. As illustrated schematically in FIG. 5A, the bellow axis 78 may be angularly displaced relative to the lateral axis 74. FIG. 5B shows an example where there are multiple sets of bellows with the bellow axes 78 substantially parallel to the lateral axis 74. FIG. 5C illustrates an example with curved bellow axes 78. In some embodiments, the set of bellows 125 or elastic pockets 126 may be disposed on a surface of the petal 120 that faces away from the finger body 110. Preferably, the elastic pockets 126 are aligned along a width of the petal 120, from one of the lateral portions 122a to another of the lateral portions 122b. Each of the elastic pocket 126 may include a respective petal cavity 128 also disposed along the lateral axis 74 (or along another axis as described above). In some embodiments, the petal cavities 128 of the petal 120 may be in fluid communication with each other. A fluid inlet 129 may be provided in fluid communication with the petal cavities 128. The fluid inlet 129 may be in fluid communication with the fluid pressure controller 60 such that a pressure in the petal cavities 128 may be varied or changed.

It may be appreciated that there may be more than one group of petal cavities 128 and therefore respective more than one fluid inlet 129. For example, the petal cavities 128a adjacent to the lateral portion 126a may be in fluid communication with each other and with a respective fluid inlet 129. The petal cavities 128a disposed on one lateral portion 122a need not be in fluid communication with the petal cavities 128b on the adjacent lateral portion 122b. It may be appreciated that multiple groups of petal cavities 128 may be provided accordingly.

Referring again to FIGS. 4A to 4B, the figures illustrate an actuation or displacement of the finger body 110 away from the finger plane 75, responsive to a change in the finger fluid pressure in the finger cavities 111. In some embodiments, with a decrease (negative change) in the finger fluid pressure in the finger cavities 111, for example providing a negative pressure in the finger cavities 111, the cavity walls of the finger cavities 111 are squeezed/moved towards each other, this causing the finger body 110 to displace 82 away from the finger plane 75, and towards the workspace volume 52. In some examples, the finger body 110 may bend about the lateral axis 74 (FIG. 2), displacing away from the finger plane 75. Similarly, with an increase (positive change) in the finger fluid pressure in the finger cavities 111, for example providing a positive pressure in the finger cavities 111, the cavity walls displace away from each other, causing the finger body 110 to displace 82 towards the finger plane 75 and away from the workspace volume 52. The petal 120 may be deformable in response to the bending of the finger body 110 and/or a change in a petal fluid pressure in the one or more petal cavities 126. The petal 120 may be deformable between any two of a plurality of shapes. Preferably, the petal 120 is deformable by a concurrent bending relative to the first axis 72 and a change in a lateral curvature 87 of the petal 120. Alternatively, the negative pressure applied may be removed, allowing the “built-in” elasticity of the wedge structure 121 to “spring back” to its default configuration. Preferably, the petal 120 is deformable towards a default shape under an elastic bias of the finger body 110 and/or the petal 120. Therefore, responsive to a change in fluid pressure in the finger cavities 111, the device 100a/100b may displace towards or away from the workspace volume 52, thus achieving part of the grasping function of the gripper 50.

Further, the displacement of the finger body 110 away from the finger plane 75 brings about a concurrent deformation and/or displacement of the petal 120 towards or away from the workspace volume 52. This is made possible by one or more couplings between the finger body 110 and the petal 120. The tip portion 124 of the petal 120 is foldable or bendable about the lateral axis 74 to form a tip curvature responsive to a displacement of the finger body 110 away from the first plane 75.

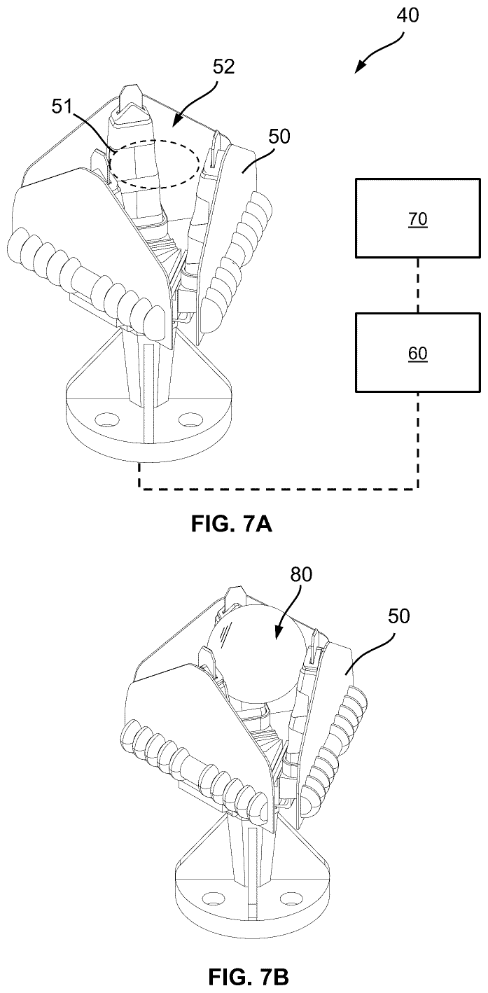

One or more of the devices 100 may be used to form various types of end-effectors. FIG. 6, FIG. 7A, and FIG. 7B illustrate a gripper 50 based on three units of the devices 100 coupled to a palm 200 via the respective finger body 110. Such a gripper 50 can be used to handle various types of objects 80 with the gripper being reconfigurable on-the-fly by changing its shape and/or surfaces for contacting the object(s) 80.

The gripper system 40 may include the gripper 50; a fluid pressure controller 60 for providing a fluid pressure to the one or more devices 100; and a controller 70 in signal communication with the fluid pressure controller 60. The controller 70 may be configured to control the fluid pressure controller 60 to vary a pressure provided to the device 100 or to vary cavity pressures in the device 100. In some examples, the fluid pressure controller 60 may include a positive pressure pump and a vaccum pump. Preferably, the fluid is a gas, such as air. Collectively, the fluid pressure controller 60 and the controller 70 may be described as forming a part of a control circuit 90.

In various embodiments, the devices 100 may be coupled to the palm 200 such that each of the devices 100 has a different orientation from one another. The finger body 110 may be coupled to a palm 200 via the connecting member 230. Each finger body 110 may be coupled to the palm 200 via a respective connecting member 230, which may in turn be displaceable relative to a center of the palm via a pneumatic actuator.

Collectively, the devices 100 may define a working aperture 51 which sets a limit on the largest cross section of an object 80 which may be grasped by the gripper system 40. The working aperture 51 may be described as the largest aperture formable by the devices 100 spaced furthest apart from one another. Further, the devices 100 and the palm 200 may define a workspace volume 52, in which the object 80 or at least a portion of the object 80 may be disposed in the workspace volume 52 during grasping operation. The “workspace volume” is the volume around the gripper that the gripper components occupy/span as they are actuated. The person skilled in the art would appreciate that the “aperture” and the “workspace volume” are two different things. The former is an area (defined by units in “meters\hat{ }2” for example or its diameter in “meters”), and the latter is a volume (units in “meter\hat{ }3”). Traditionally, workspace is defined as the range of positions a robot can reach to interact with its physical environment. In the present disclosure, the gripper 50 is a soft gripper and interactions with the object 80 can include passive and active deformations of the gripper 50, including deformations in the devices 100.

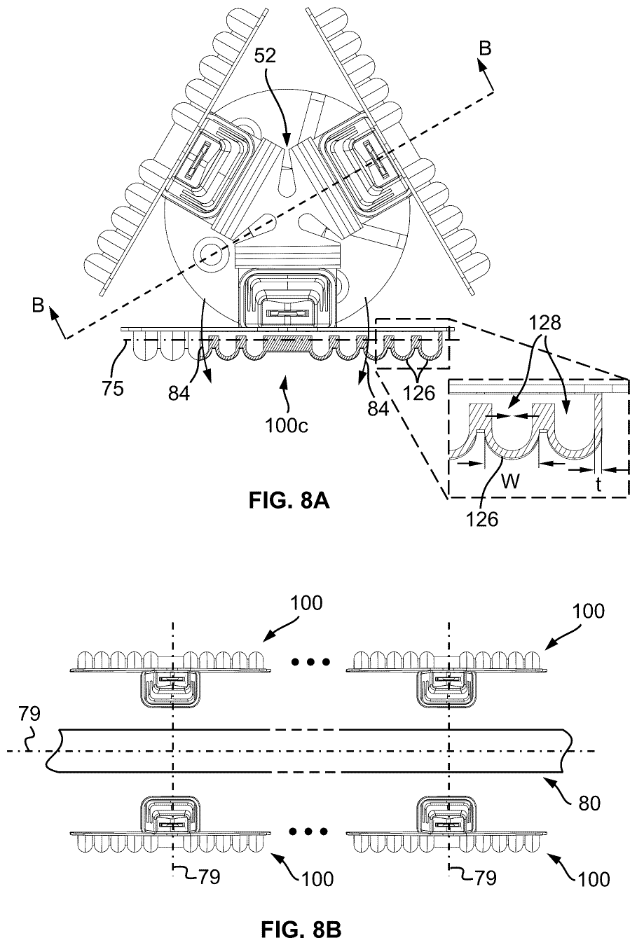

In some embodiments, the palm 200 may define a central axis 71 passing through a center of the working aperture 51. The plurality of devices 100 may be disposed in a radial symmetry about the central axis 71 of the palm 200, as illustrated in FIG. 8A. The present gripper 50 is not limited to a radially symmetrical configuration. In another non-limiting example schematically in an exploded view in FIG. 8B, a plurality of the devices 100 are coupled to a support (not shown to avoid obfuscation) such that each group of two or more of the devices 100 are better pre-oriented to handle the object 80. In the example of FIG. 8B, the gripper 50 is formed by two or more pairs of the devices 100 distributed in a mirror symmetry about an axis of symmetry 79. Depending on the application, the gripper may be characterized by more than one axis of symmetry. That is, selected ones of the plurality of devices may be distributed in a mirror symmetry about an axis of symmetry. In this example, such set-ups may be useful for handling soft and long food articles (as object 80). In some other examples, various numbers of the devices 100 may be coupled in a group and pre-oriented to facilitate integration with the production line.

The palm 200 may be attachable to a base 300 which acts as an interface member for connection to an actuator, such as a robotic arm. The gripper 50 thus may be an end effector of the robotic arm configured for displacing object(s) 80. The devices 100 may be moveable/displaceable towards a center of the workspace volume 52 of the gripper 50, similar to human fingers, to perform the grasping action for picking up the object 80. Alternatively, the devices 100 may be moveable/displaceable away from the center of the workspace volume 52 to release the object 80.

In some embodiments, each of the devices 100 may be independently controllable, or in other words, may be displaced differently, such that the devices 100 are oriented and positioned in an optimum orientation for picking up the object 80. For example, the respective finger body 110 of the plurality of devices of one gripper 50 may collectively define a working aperture, while the plurality of devices and the palm collectively define a workspace volume. For example, two of the devices 100 may be displaced or bent with different degree towards the center of the workspace volume 52, while the remaining device 100 may be held stationary. In other embodiments, each of the devices 100 may be similarly displaced, for example bending to a similar degree, such that the object is held substantially in line with the center of the workspace volume 52. In some embodiments, each of the devices 100 may be displaced such that forces on the object 80 are uniformly or evenly distributed. In other embodiments, each of the devices 100 may be displaced such that forces on the object 80 are non-uniformly distributed to avoid applying excessive forces on fragile portions of the object.

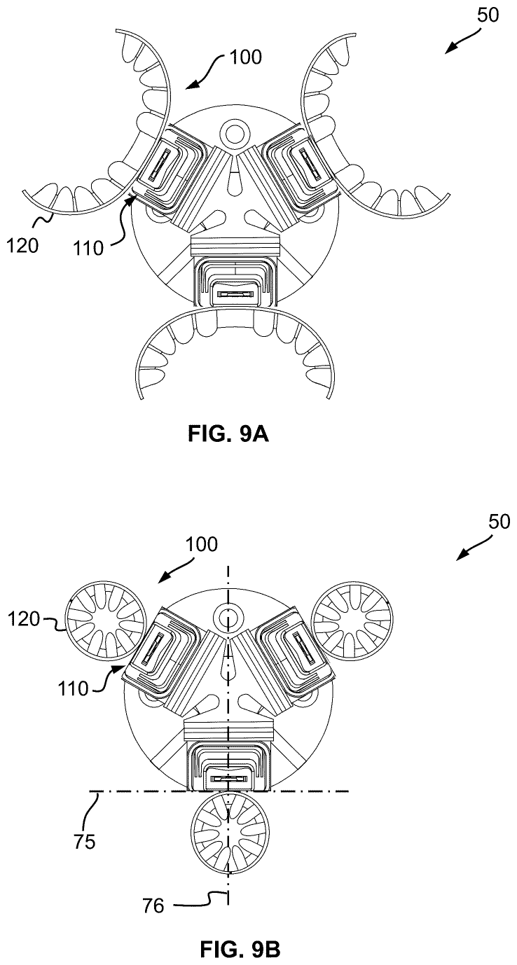

Further referring to FIGS. 8A, 8B, 9A, and 9B, various actuation or deformation and/or displacement of the petal 120 away from the finger plane 75 are illustrated. FIG. 8A schematically illustrates a default shape of the petal 120. FIG. 9A illustrates a scoop shape of the petal 120. In some examples, the petal 120 is deformable towards the scoop shape in response to the bending of the finger body 110 and an expansion of the one or more petal cavities 126 under a positive petal fluid pressure. As shown, the petal 120 in the scoop shape forms a hollow in which the finger body 110 is disposed. These and other deformation and/or displacement of the petals (device) are preferably responsive to a change in the fluid pressure (petal fluid pressure and/or finger fluid pressure) in the petal cavities 128 and/or finger cavities 110. In some embodiments, with a decrease in petal fluid pressure in the petal cavities 128, for example providing a negative pressure in the petal cavities 128, the elastic pockets 126 of the set of bellows 125 are squeezed towards each other changing a respective width of each petal cavity (e.g., elastic pocket) 126, this causing the lateral portions 122 of the petal 120 to displace 82 away from the finger plane 75, and away from the workspace volume 52. For example, as illustrated in FIG. 9B, the petal 120 is deformable towards a tubular shape in response to a contraction of the one or more petal cavities 126 under a negative fluid pressure. As illustrated schematically, the petal 120 in the tubular shape is folded away from the finger body 110. It will be understood that the term “tubular” and “folded” may be interchangeably used in the present context. In actual implementation, the folded shape of the petal 120 need not be tubular or cylindrical in shape. In some examples, the petal 120 or lateral portions 122 may bend or fold about the first axis 72, displacing away from the finger plane 75. Preferably, each of the lateral portion 122 folds relative to the first axis 72 to form a respective lateral curvature 87, responsive to the decrease in fluid pressure in the petal cavities 128. The deformation of the petal 120 may be varied and complex in various embodiments. In one aspect, the petal 120 may be described as being deformable by displacing at least one lateral portion 122. Preferably, the at least one lateral portion 122 is displaceable towards a first direction in response to a negative change in the finger fluid pressure, and towards a second direction in response to a negative change in the petal fluid pressure. The first direction and the second direction may be understood to be somewhat in different directions. The terms may also be understood in relative terms, e.g., relative to the finger body 110.

Therefore, responsive to an increase in fluid pressure in the petal cavities 128, the lateral portions 122 may displace away from the finger plane 75 along a first direction towards the workspace volume 52, and responsive to a decrease in fluid pressure in the petal cavities 128, the lateral portions 122 may displace away from the finger plane 75 along a second direction away from the workspace volume 52, wherein the second direction is opposing the first direction.

In embodiments where there are two lateral portions 122a/122b on opposing sides of the petal 120, each of lateral curvature 87 may be substantially symmetrical about a second finger plane 76 which is transverse or perpendicular to the finger plane 75. In this configuration, the lateral portions 122a/122b may be positioned behind the finger body 110, and therefore is unintrusive to grasping operations in which the finger body 110 is sufficient for operation. Therefore, when the petals 120 are under negative pressure, lateral portions 122a/122b fold onto themselves and ‘tuck’ completely behind the finger body 110 for an unobstructed access to payloads during power grasping mode.

Similarly, with an increase in fluid pressure in the petal cavities 128, for example providing a positive pressure in the petal cavities 128, the elastic pockets 126 of the set of bellows 125 are displaced away from each other, causing the lateral portions 122 of the petal 120 to displace 82 away from the finger plane 75 and towards the workspace volume 52. Therefore, responsive to a change in fluid pressure in the petal cavities 128, the petals 120c/120d may displace towards or away from the workspace volume 52.

It may be appreciated that in the embodiments where each of the lateral portion 122 is disposed adjacent to respective group of petal cavities 128, the fluid pressure in each of the group of cavities may be independently varied or controlled. Therefore, each of the lateral portions 122 may be independently displaced relative to the finger plane 75, and therefore a respective lateral curvature 87 may be formed independently.

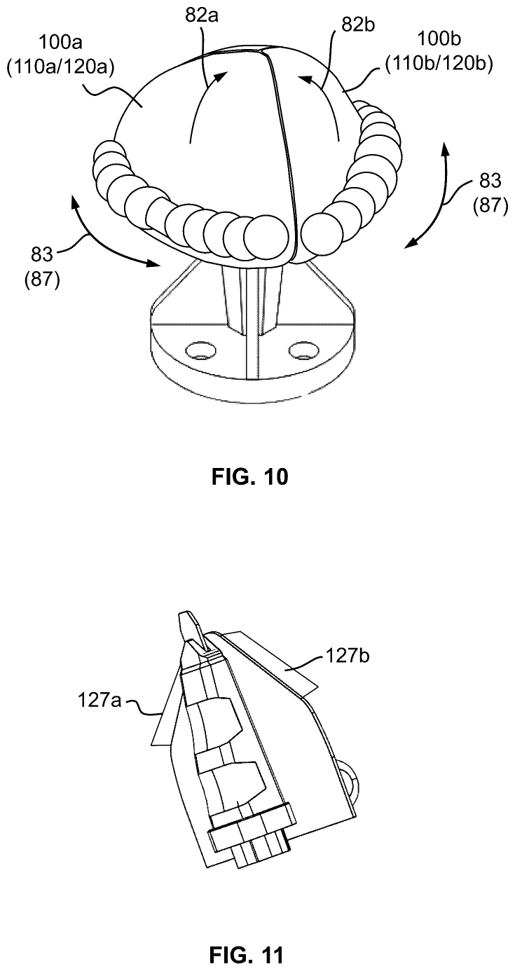

FIGS. 10 and 11 illustrate an embodiment of the gripper 50 during a grasping operation. In this embodiment, the gripper 50 includes three devices 100a/100b/100c symmetrically disposed about a central axis of the palm 200. During grasping operation, each of the finger body 110a/110b/110c is actuated by way of changing a pressure in the cavities of each of the finger body 110a/110b/110c, thereby displacing 82a/82b each of the devices 100a/100b/100c from the respective finger plane, towards the workspace volume 52. With the displacement of each of the finger body 110a/110b/110c, the respective tip portion of the petals 120a/120b/120c forms a respective tip curvature as illustrated in FIG. 10, thus forming a closed volume 54 or at least a partial closed volume 54 between the palm 200 and the plurality of devices 100a/100b/100c. Preferably, the petals 120 are configured such that they do not overlap neighboring petals. Optionally, depending on the intended application, the petals 120 may be configured or shaped such that they do overlap neighboring petals to a relatively small extent. Contrary to conventional thinking that overlapping is essential for handling small and loose objects, the present gripper was advantageously found effective for grasping small and loose objects without the petals 120 overlapping. For example, the closed volume 54 may be used for scooping or grasping small object(s), such as rice, beads, etc., which has an individual dimension smaller than a smallest working aperture 51 of the gripper 50. In some embodiments, the tip portion 122 may include at least one flap 127a/127b laterally extending or protruding laterally from a side of the petal 120, e.g., from the tip portion 122. Preferably, flaps 127a/127b (collectively, the “flaps” 127) are provided on opposing sides of the tip portion 120 along the lateral axis 74. The flap 127 may be no thicker than the petal 120. Preferably, the flap 127 is thinner than the petal 127 and does not actively deform itself independently of the petal on which it is disposed. The flaps 127a/127b may slightly overlap between the petals 120 when neighboring petals 120 are brought together. It was observed that random wrinkles or curves may form on deforming a petal 120. When the edges of two neighboring petals meet, there may be one or more gaps between the edges of the petals 120 as a result. The flap 127 overlapping provides a good seal or closure such that the random gaps are well “plugged”. It was found in experiments that this effectively increases a volume of the closed volume 54, thereby enabling a larger volume of small objects to be grasped or scooped at one instance. The flaps further prevent small objects from slipping away through any potential gaps that may be found in between the petals. The flaps serve to cover or “plug” any gaps that may appear in between the petals 120 as the petals are folded.

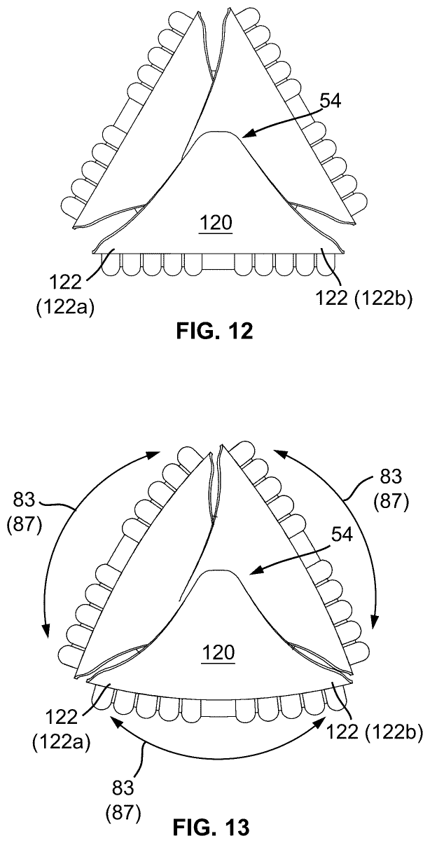

Further referring to FIGS. 12 and 13, top views of the petals 120 are illustrated during the “scoop mode” operation as described in FIGS. 10 and 11. In some embodiments as shown in FIG. 12, the lateral portions 122a/122b of each petal 120 are held substantially planar to each other with the control of pressure in the petal cavities 128. For example, the lateral curvature 87 formed may be defined along the bellow axis 78, where the bellow axis 78 is defined by a line of petal cavities 126. Therefore, three devices 100 collectively define the closed volume 54. In other embodiments as shown in FIG. 13, the lateral portions 122 of the petals 120 are displaced 83 or bent towards the workspace volume 52. This disposes the respective lateral curvature 87 and tip curvature formed by each petal 120 on the same side of each finger plane, forming a closed volume 54 similar to a Reuleaux triangle. This beneficially increases the closed volume 54 for the scooping operation.

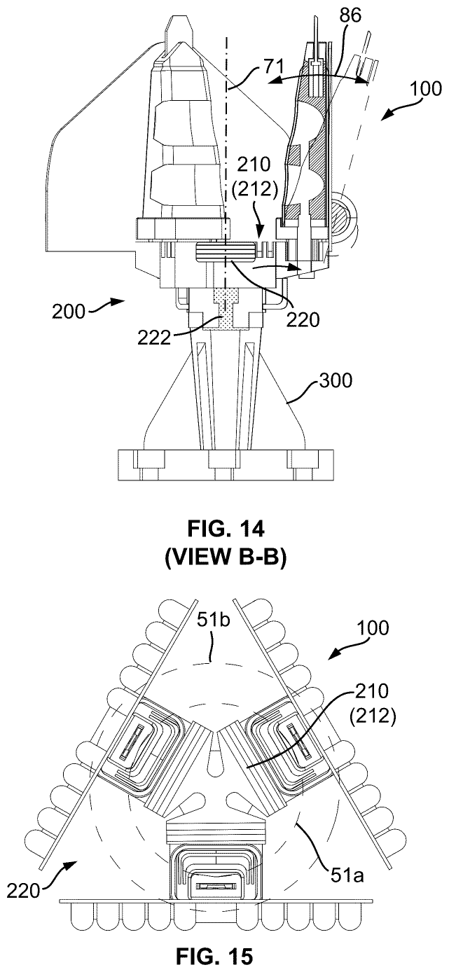

The working aperture 51 of a gripper heavily influences the range of payload sizes it can reliably grasp. In the gripper 50 as disclosed herein, working aperture control is achieved by a novel multi-material palm 200. Referring to FIGS. 14 and 15, in various embodiments, the palm 200 may be formed of multiple materials and is provided with at least one palm cavity 220 formed interior of the palm 200 in fluid communication with a fluid inlet 222. The palm 200 may be provided with couplings or connecting portions 210 corresponding to each device 100. Further, the connecting portions 210 may include recesses 210 or projections formed on surfaces of the connecting portions 210. The recesses 210 reducing the stiffness of the respective connecting portions 210, thus acting as elastic joints of the palm 200. This enables each of the connecting portions 210 to bend relative to the palm 200. With an increase or decrease in palm fluid pressure in the palm cavity 220, the palm 200 is deformed thus displacing a respective orientation of each device 100 relative to the central axis 71, or in other words, varying each respective orientation of the device 100 relative to the palm 200. For example, the palm cavity 220 is operable by the palm fluid pressure, with the plurality of the devices 100 being displaceable towards or away from one another in correspondence with a radial displacement of the respective coupling relative to the central axis. That is, the radial displacement of the devices 100 is responsive to a change in the palm fluid pressure. The working aperture and/or the workspace volume is changeable in response to a deformation of any one or more of the plurality of devices. This beneficially increases the working aperture 51a/51b and the workspace volume 52 without actuating the devices 100, providing an additional degree of freedom to each of the devices 100.

In some embodiments, the palm 200 may be soft or elastic, including a hollow chamber with a relatively stiff core, thin inflatable bellows on the top surface, and inextensible finger connectors on the sides. The stiff core and bellows result in non-uniform inflation and deflation of the palm 200 under an increase in pressure (positive pressure) and a decrease in pressure (negative pressure) respectively, thus causing a change in orientation of the devices 100 and regulation of the working aperture. Having a stiff core mitigates the issues associated with an entirely soft palm, e.g., less fluid pressure/energy for inflating the bellows and making the aperture regulation less efficient. Advantageously, a stiff core is less prone to vibrations during fast grasping and manipulation tasks.

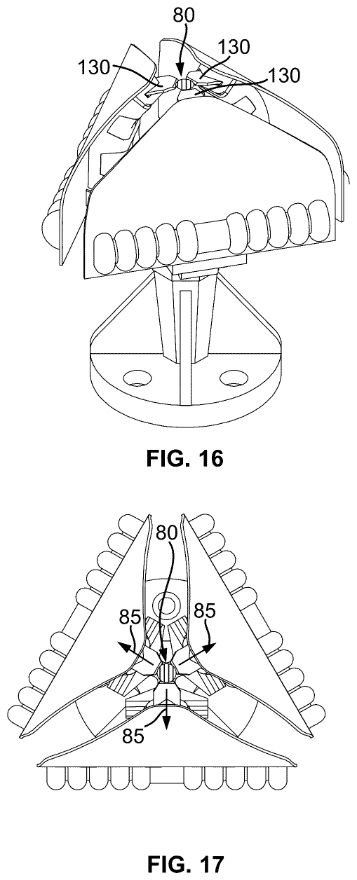

FIGS. 16 and 17 illustrates the gripper 50 picking up a thin object 80. When picking up the object 80, the nail 130 is pressed against the object and is resiliently displaceable 85 relative to the finger body 110, as such, the nail 130 is able to automatically retract and adjust its respective protrusion from the finger body 110 to be level with the surface even when there is an orientation change to the nail 130 or finger body 110. Once the nails are moved away from the object 80, the elastic member 132 pushes on the nail 130 to return to the fully extended state. This beneficially enables the grasping of thin or small items with non-uniform geometries or low surface areas, which would otherwise require precise position control if done using fixed rigid nails, as the tip position would change with the finger curvature during finger bending.

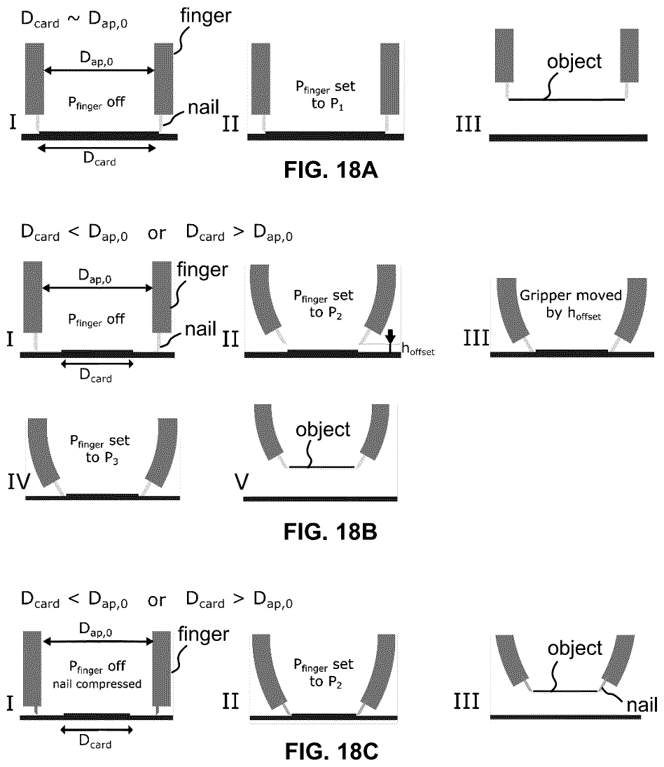

FIG. 18A to 18C illustrates different methods of pinch grasping thin items of different sizes using the gripper 50. Referring to FIG. 18A, in step (I), for thin items with dimensions similar to that of the working aperture (Dₐₚ) of the gripper (D_{card}˜Dₐₚ,0), the gripper nails (or nail) make contact with a base edge of the thin object. Subsequently, in step (II), the finger is actuated by setting finger pressure or P_{finger} to P₁. The thin object edge prevents the finger from bending significantly, hence the nail tip height/protrusion does not change much during finger actuation, resulting in a secure grasp. Finally in step (III) the thin object is lifted from the surface.

Now referring to FIG. 18B, to grasp thin items with dimensions smaller or bigger than working aperture (Dₐₚ) of the gripper ((D_{card}≠Dₐₚ,0) using rigid nails, in step (I), gripper nails make contact with flat surface. In step (II), the finger is actuated by setting P_{finger} to P₂, So that the nail tip separation can be adjusted to the dimension of the thin object. This causes the finger to bend freely, changing the nail tip height by a height offset (h_{offset}). In step (III), the gripper may be moved by the height offset (h_{offset}) to ensure that the nail tips are in the correct position. In step (IV), once the nail tips are in position, P_{finger} is set to P₃ to grasp the thin object and in step (V) to lift the thin object off the flat surface. In the case of fixed nails, height offset (h_{offset}) must be controlled precisely, so that the nails don't collide with the flat surface causing the nail tip position to inadvertently change or the fingers to lock upon actuation.

Referring to FIG. 18C, to grasp thin items with dimensions smaller or bigger than working aperture (Dₐₚ) of the gripper ((D_{card}≠Dₐₚ,0) using passively retractable nails, in step (I) before the fingers are actuated, gripper nails are preloaded, retracting the nails. In step (II), the fingers are actuated by setting P_{finger} to P₂, and the nail extends automatically as the finger bends. This causes the nail tip to stay level with the flat surface. Once the nail contacts the item, finger bending is locked. In step (III), the item is lifted off the flat surface. Therefore, the compliant nails allow for precise pinch grasping without strict position control.

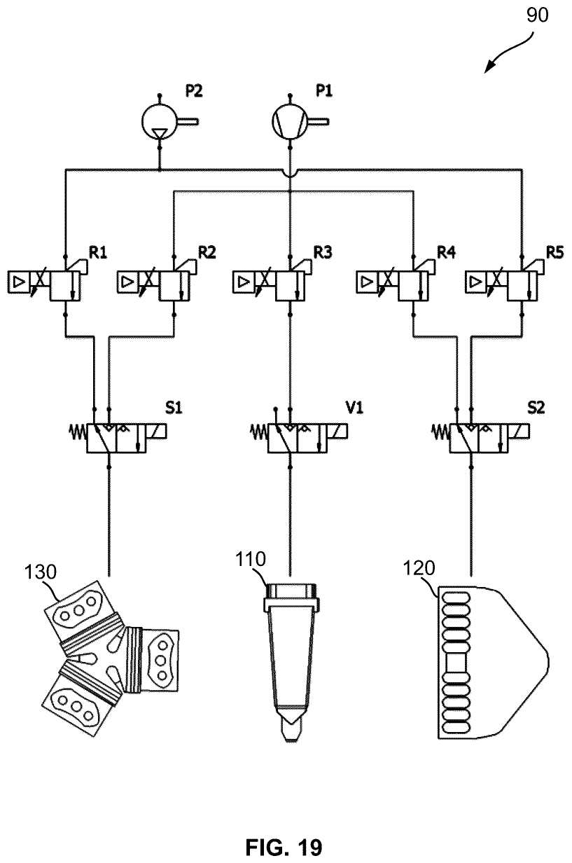

In some embodiments, in order to enable a rapid reconfiguration of the gripper 50 for different grasping modes or for grasping different objects, a pneumatic pressure source is used. FIG. 19 illustrates an electro-pneumatic actuation circuit according to an embodiment of the control circuit 90. A vacuum pump P1 and an air compressor P2 serve as sources for negative and positive pressure respectively. Electro-pneumatic regulators R1-R5 adjust the positive and negative pressure applied to the palm and fingers. All regulators are powered using 24V and controlled using analog voltages between 0-5V supplied by the robotic arm I/O controller. For bi-directional actuation of the palm and petals, selector valves S1 and S2 are used to switch between the regulated positive pressure, regulated negative pressure, and exhaust. A solenoid valve V1 enables or disables the finger vacuum actuation. All valves are triggered using 24V digital outputs from the robotic arm I/O controller. Thus, independent actuation and pressure control of the devices 100, including the finger body 110 and the petal 120, and the palm 200 was achieved.

In various embodiments, the gripper 50 may include individually or independently actuatable parts, such as a palm and one or more fingers. Each of the finger may further include independently actuatable finger body and petal. In other words, the control circuit 90 is configured to control each of the following independently of any other in the group consisting of: the finger fluid pressure, the petal fluid pressure, and the palm fluid pressure, where the finger fluid pressure refers to the fluid pressure provided to the finger cavities 110, the petal fluid pressure refers to the fluid pressure provided to the petal cavities 126, and the palm fluid pressure refers to the fluid pressure provided to the palm cavity 220. By controlling each of the actuatable parts, the gripper may be provided with multiple degrees of freedom of control, and thus may be adapted or reconfigured for various purposes or objectives.

In some embodiments, the gripper 50 may be actuatable by use of a fluid, such as air, causing a change in fluid pressure in one or more cavities formed in the gripper. This enables a quick response time due to the pneumatic nature of the actuator, and provides a balance between speed and strength on the grasping force. Further, different materials may be employed for the gripper, making use of differential stiffness in the materials in achieving actuation.

For sake of clarity, the term “decrease in fluid pressure” may be understood to include forming a negative pressure relative to the surrounding, by use of, for example, a vacuum pump. Further, the term “increase in fluid pressure” may be understood to include forming a positive pressure relative to the surrounding, by use of, for example, a pressure pump. The term “fluid” may be understood to include at least one of: a gas, a liquid, or a combination thereof.

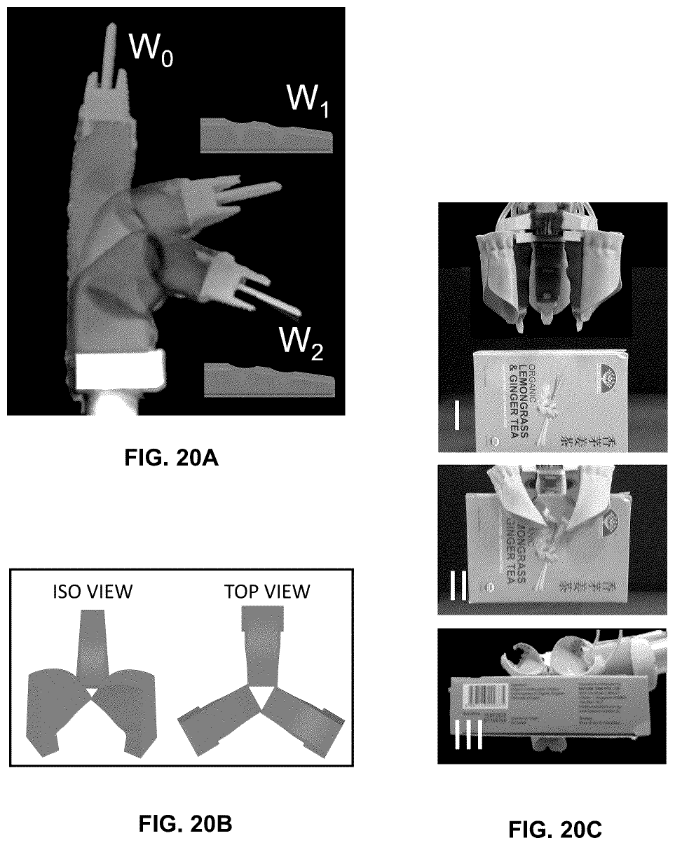

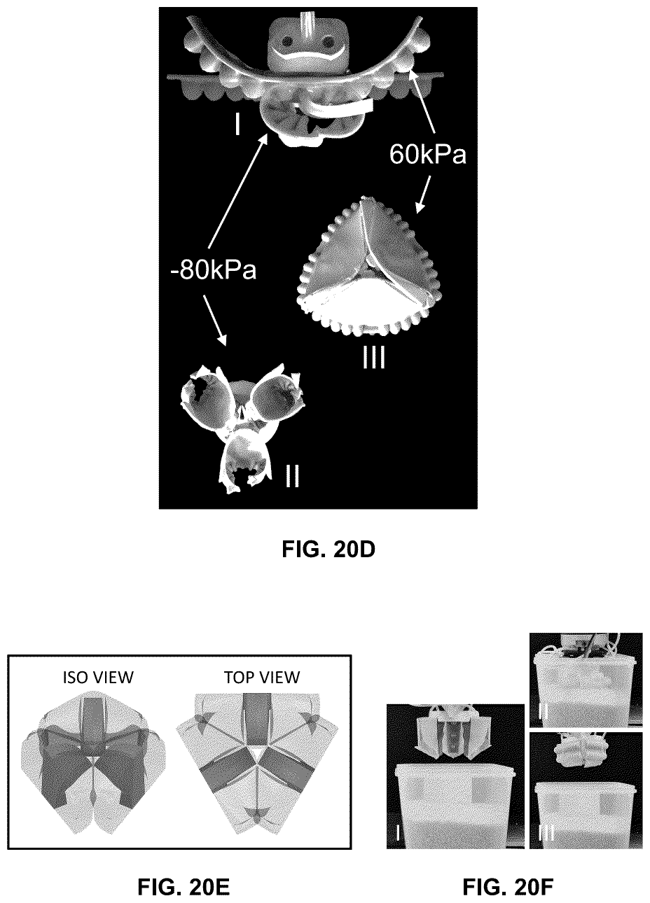

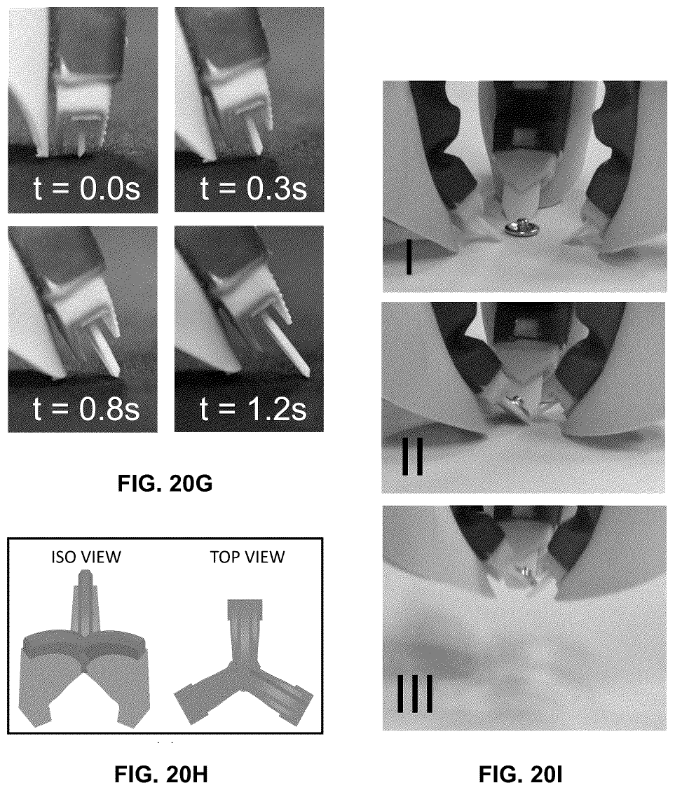

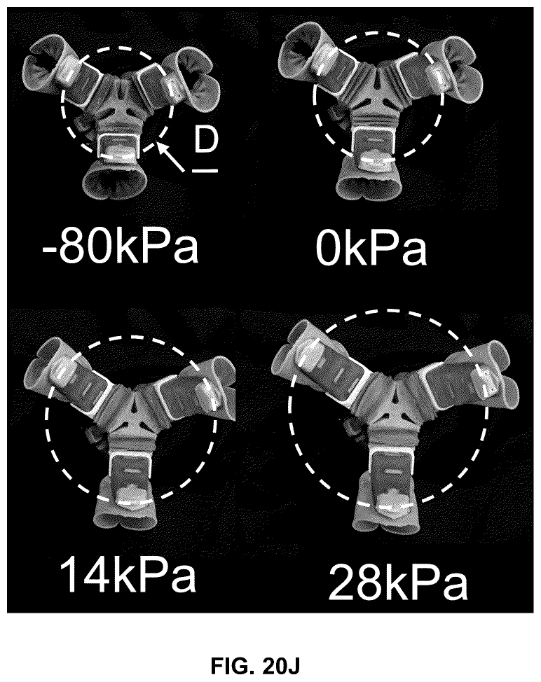

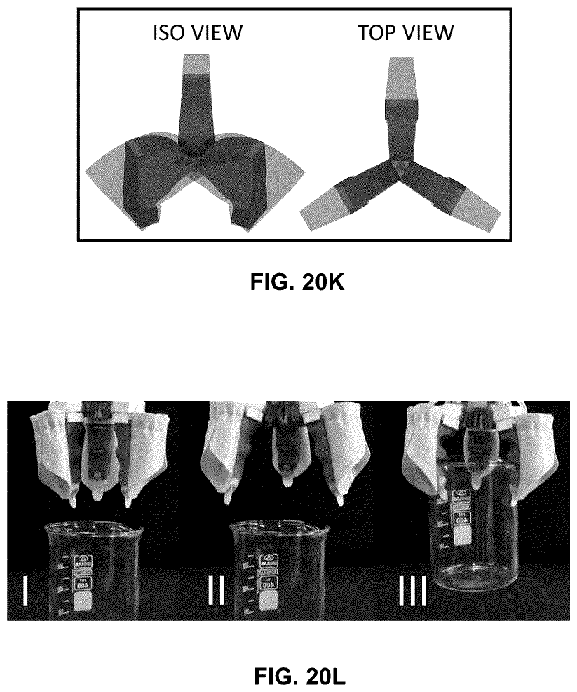

FIG. 20A to FIG. 20L illustrate the various actuation modes and corresponding grasping workspaces. FIG. 20A shows an overlay image showing various finger bending states, state W0 is the un-actuated finger, while states W1 and W2 show two finger bending states. The inset drawings highlight the elliptical cavities (W2). FIG. 20B shows isometric and top views of the gripper workspace in power grasping mode, wherein each finger behaves as a distinct cylindrical bending actuator. In FIG. 20B, only fingers 110 are shown, the petals and nails are removed for clarity. FIG. 20C shows spherical or cylindrical grasping mode for large payloads: In (I), vacuum is applied to the petals to tuck them behind the fingers. This allows the fingers to approach and secure power grips around payloads with large dimensions. In (II), fingers are actuated using vacuum and the gripper is moved up. In (III) Bottom view of the grasped payload shows how petals curled backwards allow finger actuators to reliably grasp the payload. In this example the payload is a tea box weighing 380 g.

Referring to FIG. 20D, in (I) shows an overlaid bottom views of petal curvatures under −80 kPa, un-actuated, and at 60 kPa respectively. In (II) is a top view of the actuated gripper with petals folded under vacuum are shown, and in (III) is a top view of the actuated gripper with petals under positive pressure, reducing the gaps between the fingers for reliable scooping grasps. FIG. 20E shows isometric and top views of the a workspace of fingers combined with petals, in the absence of nails (workspace associated with the fingers in a darker shade and the workspace associated with the petals highlighted in a lighter shade. FIG. 20F shows a scoop grasping mode: in (I), vacuum is applied to the petals to increase the stiffness of the fingers along the lateral axis, allowing the petals to penetrate the granular medium (uncooked white rice). In (II), once the gripper reaches the desired penetration depth, the petals are actuated using 60 kPa positive pressure to achieve forward petal bending while the fingers are simultaneously bent. In (III), rice is trapped inside the resultant closed volume and lifted.

FIG. 20G shows passive compliant actuation of the nail when the finger bends against a flat surface, resulting in appropriate nail retraction and continuous contact with the flat surface. FIG. 20H shows isometric and top views of the gripper's reconfigured workspace, highlighting the workspace of the nails in a different shade. In FIG. 20I, a pecision grasp mode for low form factor items: in (I), the fingertips are brought in contact with the flat surface. In (II), the fingertips (i.e. nails) adjust in length as the fingers bend. This ensures good fingertip contact with the payload (8 mm diameter stitch button) despite possible small errors in endeffector alignment or unequal finger bending. In (III), due to improved contact, the nails lift the button, and the gripper is moved up.

FIG. 20J illustrates the variation of palm aperture D with applied pressure, from 41 mm at −80 kPa to 139 mm at 28 kPa. FIG. 20K shows isometric and top views of the workspace associated with the fingers, showing how this workspace changes due tothe palm. The change (the increase in workspace allowing the previously bending fingers to grasp over a larger volume) is highlighted in a lighter shade. FIG. 20L shows the variable aperture grasping mode: in (I) The un-actuated gripper aperture is approximately 62 mm, which is small for a glass beaker. In (II), the palm is actuated with 28 kPa to increase the aperture to 126 mm, which provides enough area for the gripper to approach the beaker. In (III), the actuation pressure is removed from the palm to allow fingers to contact the beaker, while vacuum is applied on the fingers to increase contact and lift the beaker.

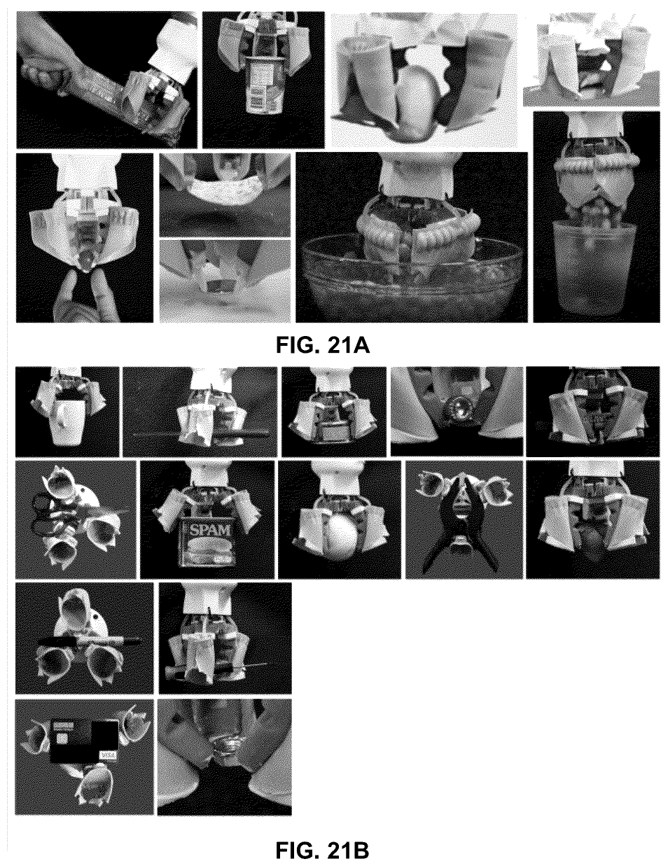

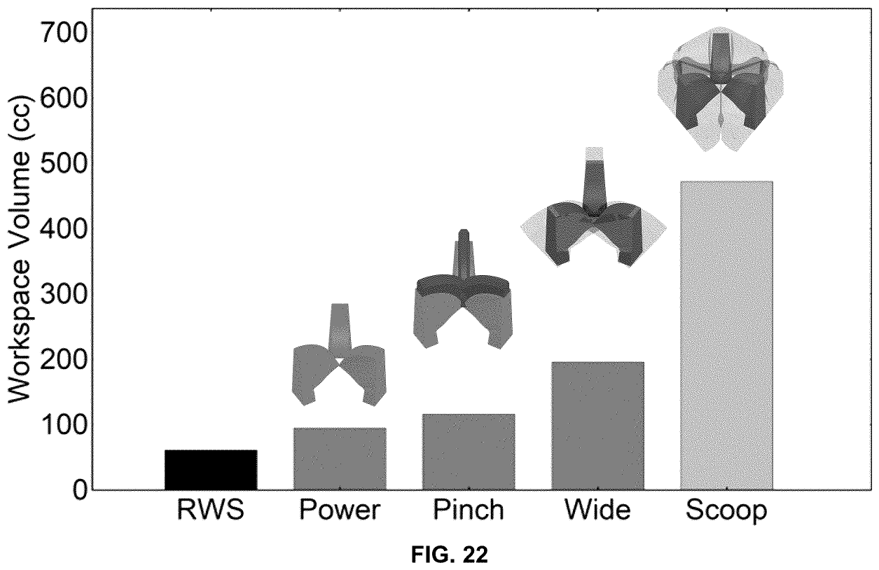

FIG. 21A and FIG. 21B illustrate the various objects being picked up by the gripper 50 and gripper system 40 of the present disclosure. FIG. 22 further includes a comparison of the workspace volumes that the RWS gripper is capable of between the four modes or operation, i.e., a power mode (power grasp mode), a pinch mode, a wide mode, and a scoop mode. The gripper workspace volume in the default mode or unactuated state (‘RWS’) is also plotted for reference. As evident from the foregoing, the present device, gripper and/or gripper system enable on-the-fly switching (changing) between different modes of operation, e.g., between any two of the plurality of modes of operation. The term “on-the-fly” as used herein refers to an event occurring concurrently (or at least partially overlapping in time) with on-going operation(s) of the gripper 50 or the gripper system 40. In other words, downtime for the purpose of switching out the end-effector to perform different tasks becomes unnecessary.

Alternatively described, various embodiments of the present device includes: a finger body, the finger body including one or more finger cavities disposed along a length of the finger body, the length of the finger body in a default shape defining a first axis, the finger body being bendable away from the first axis in response to a change in a finger fluid pressure in the one or more finger cavities; and a petal, the petal being coupled to the finger body at one or more points along the length of the finger body, the petal having one or more petal cavities disposed thereon, wherein the petal is actively deformable and/or passively deformable in response to the bending of the finger body and/or a change in a petal fluid pressure in the one or more petal cavities.

The device according to the above, wherein the petal is deformable between any two of a plurality of shapes. Preferably, the petal is deformable by a concurrent bending relative to the first axis and a change in a lateral curvature of the petal.

Preferably, the one or more petal cavities comprises a plurality of the petal cavities distributed along one or more bellows axes, and wherein the lateral curvature is defined along the one or more bellows axes. Preferably, at least one of the one or more bellows axes is non-parallel to the first axis.

Preferably, wherein the petal comprises at least one lateral portion, and wherein the petal is deformable by displacing the at least one lateral portion. Preferably, the at least one lateral portion is displaceable towards a first direction in response to a negative change in the finger fluid pressure, and wherein the at least one lateral portion is displaceable towards a second direction in response to a negative change in the petal fluid pressure, the second direction opposing the first direction.

Preferably, the petal is deformable towards a scoop shape in response to the bending of the finger body and an expansion of the one or more petal cavities under a positive petal fluid pressure, the petal in the scoop shape forming a hollow in which the finger body is disposed. Preferably, the petal is deformable towards a tubular shape in response to a contraction of the one or more petal cavities under a negative fluid pressure, the petal in the tubular shape being folded away from the finger body. Preferably, the petal is deformable towards a default shape under an elastic bias of the finger body and/or the petal.

Preferably, the petal defines a first surface and a second surface opposing the first surface, and wherein the petal is coupled to the finger body at the first surface, and wherein the one or more petal cavities are disposed on the second surface. Preferably, the device comprises a nail elastically coupled to the finger body, wherein the nail is resiliently displaceable along the first axis relative to the finger body. Preferably, the device comprises a flap extending laterally from a side of the petal.

According to various embodiments, the present gripper includes: a palm defining a central axis; and a plurality of devices, each of the plurality of devices according to any device described above, wherein each of the plurality of devices is coupled to the palm via a respective coupling independently of any other of the plurality of devices, and wherein the respective finger body of the plurality of devices collectively define a working aperture, and wherein the plurality of devices and the palm collectively define a workspace volume.

The gripper as described above, wherein any one or both of the working aperture and the workspace volume is changeable in response to a deformation of any one or more of the plurality of devices. Preferably, the device further comprises a palm cavity operable by a palm fluid pressure, wherein the plurality of the devices are displaceable towards or away from one another in correspondence with a radial displacement of the respective coupling relative to the central axis, the radial displacement being responsive to a change in the palm fluid pressure.

Preferably, the plurality of devices are distributed in a radial symmetry about the central axis. Preferably, selected ones of the plurality of devices are distributed in a mirror symmetry about an axis of symmetry Preferably, the gripper is changeable between any two of a plurality of modes of operation, and wherein the plurality of modes of operation comprises: a default mode, a pinch mode, a power mode, a wide mode, and a scoop mode. Preferably, the gripper is configurable to form at least a partial closed volume between the palm and the plurality of devices.

According to various embodiment, the present gripper system includes: a control circuit; and a gripper according to any gripper described above, the gripper being operably coupled to the control circuit, wherein the control circuit is configured to control each of the following independently of any other in the group consisting of: the finger fluid pressure, the petal fluid pressure, and the palm fluid pressure.

In industrial environments, reliable robotic handling of goods depends heavily on the development of versatile grippers with comprehensive and adaptive capabilities. In comparison to traditional rigid grippers, the grippers proposed herein can be combined with functional hyper-elastic materials and the compliant soft actuators described to enable grasping of a wider range of geometries safely and reliably. As shown in the foregoing, various embodiments of the gripper and the device are capable of multiple modes of operation through shape morphing. The gripper and the device can be reconfigured on-the-fly to switch between different modes of operation, to change the working aperture, and/or to change the workspace volume, without requiring a downtime for physical switching out of components. Advantageously, the shape morphing can be performed by controlling actuators via a computing device executing instructions stored on a computer readable medium. As a result of the on-the-fly reconfigurability, any one of the various embodiments of the gripper may be used for various payloads and tasks.

1. A device comprising:
a finger body, the finger body including one or more finger cavities disposed along a length of the finger body, the length of the finger body in a default shape defining a first axis, the finger body being bendable away from the first axis in response to a change in a finger fluid pressure in the one or more finger cavities; and
a petal, the petal being coupled to the finger body at one or more points along the length of the finger body, the petal having one or more petal cavities disposed thereon,
wherein the petal is actively deformable and/or passively deformable in response to the bending of the finger body and/or a change in a petal fluid pressure in the one or more petal cavities.

2. The device according to claim 1, wherein the petal is deformable between any two of a plurality of shapes.

3. The device according to claim 1, wherein the petal is deformable by a concurrent bending relative to the first axis and a change in a lateral curvature of the petal.

4. The device according to claim 3, wherein the one or more petal cavities comprises a plurality of the petal cavities distributed along one or more bellows axes, and wherein the lateral curvature is defined along the one or more bellows axes.

5. The device according to claim 4, wherein at least one of the one or more bellows axes is non-parallel to the first axis.

6. The device according to claim 1, wherein the petal comprises at least one lateral portion, and wherein the petal is deformable by displacing the at least one lateral portion.

7. The device according to claim 6, wherein the at least one lateral portion is displaceable towards a first direction in response to a negative change in the finger fluid pressure, and wherein the at least one lateral portion is displaceable towards a second direction in response to a negative change in the petal fluid pressure, the second direction opposing the first direction.

8. The device according to claim 1, wherein the petal is deformable towards a scoop shape in response to the bending of the finger body and an expansion of the one or more petal cavities under a positive petal fluid pressure, the petal in the scoop shape forming a hollow in which the finger body is disposed.

9. The device according to claim 1, wherein the petal is deformable towards a tubular shape in response to a contraction of the one or more petal cavities under a negative fluid pressure, the petal in the tubular shape being folded away from the finger body.

10. The device according to claim 1, wherein the petal is deformable towards a default shape under an elastic bias of the finger body and/or the petal.

11. The device according to claim 1, wherein the petal defines a first surface and a second surface opposing the first surface, and wherein the petal is coupled to the finger body at the first surface, and wherein the one or more petal cavities are disposed on the second surface.

12. The device according to claim 1, further comprising a nail elastically coupled to the finger body, wherein the nail is resiliently displaceable along the first axis relative to the finger body.

13. The device according to claim 1, further comprising a flap extending laterally from a side of the petal.

14. A gripper comprising:
a palm defining a central axis; and
a plurality of devices, each of the plurality of devices including:
a finger body, the finger body including one or more finger cavities disposed along a length of the finger body, the length of the finger body in a default shape defining a first axis, the finger body being bendable away from the first axis in response to a change in a finger fluid pressure in the one or more finger cavities; and
a petal, the petal being coupled to the finger body at one or more points along the length of the finger body, the petal having one or more petal cavities disposed thereon,
wherein the petal is deformable in response to the bending of the finger body and/or a change in a petal fluid pressure in the one or more petal cavities,
wherein each of the plurality of devices is coupled to the palm via a respective coupling independently of any other of the plurality of devices,
and wherein the respective finger body of the plurality of devices collectively define a working aperture,
and wherein the plurality of devices and the palm collectively define a workspace volume.

15. The gripper according to claim 14, wherein any one or both of the working aperture and the workspace volume is changeable in response to a deformation of any one or more of the plurality of devices.

16. The gripper according to claim 14, further comprising a palm cavity operable by a palm fluid pressure, wherein the plurality of the devices are displaceable towards or away from one another in correspondence with a radial displacement of the respective coupling relative to the central axis, the radial displacement being responsive to a change in the palm fluid pressure.

17. The gripper according to claim 14, wherein the plurality of devices are distributed in a radial symmetry about the central axis.

18. The gripper according to claim 14, wherein selected ones of the plurality of devices are distributed in a mirror symmetry about an axis of symmetry.

19. The gripper according to claim 14, wherein the gripper is changeable between any two of a plurality of modes of operation, and wherein the plurality of modes of operation comprises: a default mode, a pinch mode, a power mode, a wide mode, and a scoop mode.

20. (canceled)

21. A gripper system, comprising:
a control circuit; and
a gripper operably coupled to the control circuit, the gripper including:
a palm defining a central axis; and
a plurality of devices, each of the plurality of devices including:
a finger body, the finger body including one or more finger cavities disposed along a length of the finger body, the length of the finger body in a default shape defining a first axis, the finger body being bendable away from the first axis in response to a change in a finger fluid pressure in the one or more finger cavities; and
a petal, the petal being coupled to the finger body at one or more points along the length of the finger body, the petal having one or more petal cavities disposed thereon,
wherein the petal is deformable in response to the bending of the finger body and/or a change in a petal fluid pressure in the one or more petal cavities,
wherein each of the plurality of devices is coupled to the palm via a respective coupling independently of any other of the plurality of devices,
and wherein the respective finger body of the plurality of devices collectively define a working aperture,
and wherein the plurality of devices and the palm collectively define a workspace volume,
and wherein the control circuit is configured to control each of the following independently of any other in the group consisting of: the finger fluid pressure, the petal fluid pressure, and the palm fluid pressure.
